(19) United States
(12) Patent Application Publication
(10) Pub. No.: US 2009/0257237 A1
(43) Pub. Date: Oct. 15, 2009

(54) SAFETY SYSTEM UTILIZING LIGHTING INCORPORATED INTO APPAREL

(76) Inventor: Mark Kincart, Gunnison, CO (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/393,831

(22) Filed: Feb. 26, 2009

Related U.S. Application Data
(60) Provisional application No. 61/031,414, filed on Feb. 26, 2008.

(51) Int. Cl. B60Q 1/00; F21V 21/08

(52) U.S. Cl. 362/459; 362/103

(57) ABSTRACT

A safety system and apparatus which incorporates an illumination member into an article of apparel where the illumination member is capable of being activated so that it simultaneously corresponds to the illumination of a lighting system of a motor vehicle. A safety device kit includes an illumination member capable of being illuminated that can be contained within, or attached to, a wearable article that can be worn by a user and a separate activation device capable of activating an illumination member.

### CROSS-REFERENCE TO RELATED APPLICATIONS

This application claims the benefit and priority of U.S. Provisional Patent Application having Ser. No. 61/031,414, filed Feb. 26, 2008, which is herein incorporated by reference.

### FIELD OF INVENTION

The present invention generally relates to a safety system and apparatus which utilizes lighting incorporated into a user's apparel which has the capability of simultaneously corresponding to the movement of an object or person. In particular, the present invention relates to a safety system and apparatus which incorporates an illumination member into an article of apparel where the illumination member is capable of being activated such that it simultaneously corresponds to the illumination of a lighting system of a motor vehicle, such as a motorcycle.

### BACKGROUND OF THE INVENTION

There has been an increased trend in utilizing more fuel efficient vehicles such as motorcycles and scooters for transportation. In addition, there has also been an increased trend in the utilization of all terrain vehicles (ATVs) and the like for recreation as well as work-related uses by law enforcement personnel, search and rescue teams, firefighters, forestry workers, national park workers, construction workers, and department of transportation workers. All of these vehicles are inherently more dangerous than other types of vehicles where drivers and passengers are completely contained within the vehicles. In addition, due to the smaller profile of these vehicles, they are less visible than other types of vehicles which in turn makes their riders and passengers less visible to drivers of other vehicles.

The smaller profile and lower visibility of the users and riders of these vehicles create additional safety concerns in comparison to other regular sized vehicles. For example, motorcycles are typically involved in motor vehicle accidents due to the inability of the drivers of other vehicles to see the small taillights found on the rear of most motorcycles. The smaller profiles of vehicles such as motorcycles, scooters, all terrain vehicles, and the like result in lighting systems contained on these vehicles which are much smaller than those contained on other vehicles. As a result, their visibility at night is greatly reduced.

Accordingly, there is a need for a system and apparatus which increases the safety of vehicles such as scooters, motorcycles, and all terrain vehicles by enhancing the visibility of these vehicles and their riders and passengers at night. Such a system should reduce collisions involving these vehicles which would in turn reduce injuries and fatalities.

### SUMMARY OF THE INVENTION

The present invention is directed to a safety system which generally includes an article of apparel, an illumination member capable of being illuminated incorporated into or attached to the article of apparel, and an activation device capable of activating the illumination member so that the activation of illumination member corresponds to the illumination of a lighting system of a motor vehicle. The activation of the illumination member may correspond to the illumination of a turn signal of the motor vehicle and/or a brake light of the motor vehicle.

In one exemplary embodiment of the safety system, the illumination member may comprise at least one light emitting diode. In another exemplary embodiment of the safety system, the illumination member may comprise a strip of material containing a plurality of light emitting diodes where the strip of material containing the light emitting diodes is contained within, or attached to, a back of an article of apparel.

The activation device capable of activating the illumination member is connected to the motor vehicle and may include a coupling member for connecting the activation device to the illumination member. In one exemplary embodiment, the coupling member may be a magnetic coupling member so that the connection to the motor vehicle easily breaks free if a rider or user of the safety system forgets to uncouple the activation device when dismounting the motor vehicle. In another exemplary embodiment, the activation device capable of activating the illumination member includes wireless technology which enables the device to illuminate the illumination member without using wires connecting the activation device to the illumination member.

The article of apparel may comprise any article that is wearable by a user or a rider. In one exemplary embodiment, the article of apparel may include a vest that can be worn over any driver or rider's shirt or jacket. In such an exemplary embodiment of the article of apparel, the illumination member may be sewn into a back of the vest. Alternatively, the illumination member may be incorporated into the vest by placing it into a clear zippered pocket contained on the back of the vest.

The present invention is also directed to a safety device kit which includes an illumination member capable of being illuminated that can be contained within, or attached to, a wearable article that can be worn by a user and a separate activation device capable of activating the illumination member. In accordance with one aspect of the invention, the separate activation device is connected to the illumination member and to a moving person or object. In one exemplary embodiment of the safety device kit, the illumination of the illumination member may correspond to the movement or nonmovement of a person or object. In another exemplary embodiment of the safety device kit, the separate activation device may activate the illumination member via wireless technology.

### BRIEF DESCRIPTION OF THE DRAWINGS

The subject invention will hereinafter be described in conjunction with the appended drawing figures, wherein like numerals denote like elements, and

FIG. 1 is a rear view of one exemplary embodiment of the safety system of the present invention;

FIG. 2 is a front elevational view of another exemplary embodiment of the safety system of the present invention; and

FIG. 3 is a rear elevational view of the exemplary embodiment of the safety system of the present invention shown in FIG. 2.

### DETAILED DESCRIPTION

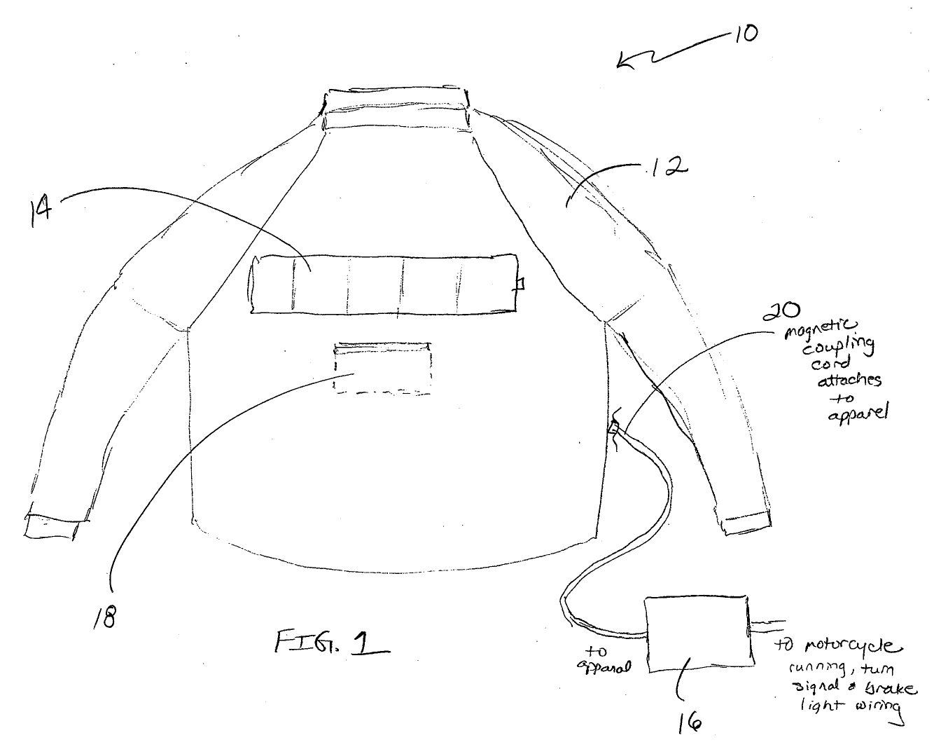

The present invention generally provides a safety system and apparatus which incorporates an illumination member into an article of apparel where the illumination member is capable of being activated such that it simultaneously corresponds to the illumination of the lighting system of a motor vehicle, such as a motorcycle, for example. The safety system 10 of the present invention includes an article of apparel 12, an illumination member 14, and an activation device 16 that is capable of activating the illumination member 14 such that illumination of the illumination member 14 simultaneously corresponds to the illumination of a lighting system of a motor vehicle. Illumination member 14 may be incorporated into, or attached to, the back of an article of apparel 12 as shown in FIG. 1. Illumination member 14 may be sewn directly into or on article of apparel 12 or may be placed within a clear pocket 18 so that illumination member 14 can be clearly seen through pocket 18.

Activation device 16 is connected to a lighting system of a motor vehicle (not shown) and is also connected to illumination member 14 contained in, or attached to, article of apparel 12. Upon activation of the lighting system of a motor vehicle, activation device 16 activates illumination member 14 so that illumination member 14 is simultaneously illuminated when one or more lights contained within a lighting system of the motor vehicle are illuminated. For example, activation of illumination member 14 may simultaneously occur with the illumination of a turn signal of a motor vehicle or, alternatively, illumination member 14 may simultaneously illuminate when a brake light of a motor vehicle is illuminated.

In another exemplary embodiment, activation device 16 may be coupled to the lighting system of a motor vehicle and further incorporate wireless technology which enables activation device 16 to simultaneously illuminate illumination member 14 without using wires to connect activation device 16 to illumination member 14. Illumination member 14 may include on or more light emitting diodes (LEDs) or any other light sources such as, but not limited to, gas discharge lamps, neon lamps, mercury-vapor lamps, lasers, chemoluminescence, fluorescence, cathode luminescence, visible radiation, or any other means by which light may be produced. A coupling member 20 may be utilized to connect activation device 16 to illumination member 14. Coupling member 20 may be a magnetic coupling member so that connection of safety system 10 to a motor vehicle (not shown) easily breaks free if a rider or user of article of apparel 12 forgets to uncouple activation device 16 when dismounting the motor vehicle.

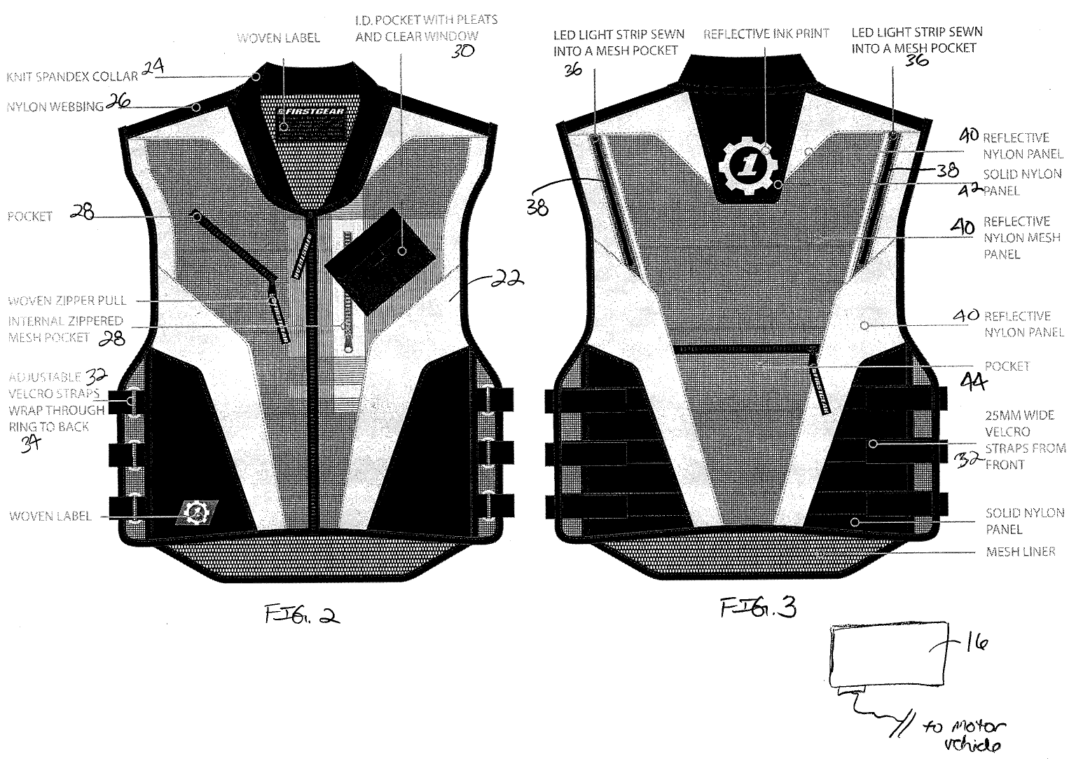

FIGS. 2 and 3 show another exemplary embodiment of the safety system of the present invention. More particularly, FIG. 2 shows a front elevational view of a vest 22 which can be worn by a driver or rider of a motor vehicle such as a motorcycle. Vest 22 includes a knit spandex collar 24, nylon webbing 26, one or more pockets 28, some of which may include clear plastic windows 30, and adjustable Velcro straps 32 which wrap through rings 34 to the back of vest 22. FIG. 3 shows a rear elevational view of vest 22 which incorporates an illumination member 14 in the form of an LED light strip 36 which is sewn into a mesh pocket 38. The rear of vest 22 may also include a reflective panel 40 and/or a solid non-reflective panel 42. The back of vest 22 may also include one or more pockets 44.

FIG. 3 also shows activation device 16 which is capable of being coupled to a lighting system of a motor vehicle (not shown). Activation device 16 shown in FIG. 3 contains wireless technology which enables activation of LED light strip 36 so that it simultaneously is illuminated with a portion of the lighting system of a motor vehicle.

The present invention is also directed to safety kit which includes an illumination member capable of being illuminated that can be contained within, or attached to, a wearable article that can be worn by a user and a separate activation device capable of activating the illumination member. The separate activation device is connected to the illumination member and to one or more of a person or object. Illumination of the illumination member corresponds to at least one of movement or nonmovement of the person(s) or object(s). Alternatively, the separate activation device may activate the illumination member via wireless technology.

The safety system of the present invention which includes an article of apparel, an illumination member capable of being illuminated incorporated into, or attached to, the article of apparel, and an activation device capable of activating the illumination member so that the activation of the illumination member corresponds to the illumination of a lighting system of a motor vehicle such as a motorcycle may be introduced into commerce in two separate phases. In phase one, a motorcycle dealer or motorcycle owner/consumer wires an activation device or logic box which sends signals to an illumination member into the motorcycle's rear running light, turn signal, brake light wiring or other lighting or wiring connected to a motorcycle's lighting system. The activation device is also coupled to an illumination member, such as a permanently placed LED array, sewn into, or attached to, the back of an article of apparel. The activation device may be coupled to the illumination member via a magnetic coupling cord which insures that the connection of the illumination member to the activation device breaks free if a rider or user dismounts the motorcycle without first unplugging or decoupling the activation device from the illumination member. Coupling of the illumination member and activation device may be performed by a power cord or any other means which enables a signal to be carried from the activation device to the illumination member. The safety system may also come in a kit form which includes a separate illumination member that can be placed within any pocket or window contained within a piece of apparel.

In a second phase, the safety system of the present invention may be incorporated into commerce by utilizing wireless technology. Once appropriate government approval is obtained, wireless technology may be applied to provide wireless activation of an illumination member contained within, or attached to, an article of apparel once a rider is seated on a motorcycle and the ignition on the motorcycle is placed in the “on” position. The addition of a rechargeable battery may be added to the illumination device or article of apparel that the illumination device is incorporated into. In addition, a pocket may be added to the kit to hold a power supply. The safety system of the present invention may also comprise self contained units for non-powered modes of transportation.

There are a multitude of applications for the safety system of the present invention. Aside from being utilized for riders of motorcycles, including stepthrough vehicles, scooters, all terrain vehicles and utility vehicles that may be used by one or more of law enforcement officers, U.S. Forestry workers, national park workers, construction workers, and department of transportation workers, the safety system of the present invention may also be used for recreation or work by others. For example, the safety system of the present invention or safety device kit of the present invention may be utilized by bicyclers, horseback riders, search and rescue personnel, and canine police or search dogs. In addition, the safety system of the present invention can be incorporated into baby strollers and other moveable objects besides apparel that may be worn by a user.

Although the invention has been described herein in conjunction with the appended drawings, those skilled in the art will appreciate that the scope of the invention is not so limited. Modifications in the selection, design, and arrangement of the various components discussed herein may be made without departing from the scope of the invention.

1. A safety system comprising:
an article of apparel;
an illumination member capable of being illuminated incorporated into, or attached to, the article of apparel; and
an activation device capable of activating the illumination member such that activation of the illumination member corresponds to the illumination of a lighting system of a motor vehicle.

2. The safety system of claim 1 wherein the activation of the illumination member corresponds to the illumination of a turn signal of the motor vehicle.

3. The safety system of claim 1 wherein the activation of the illumination member corresponds to the illumination of a brake light of the motor vehicle.

4. The safety system of claim 1 wherein the illumination member comprises at least one light emitting diode.

5. The safety system of claim 4 wherein the illumination member comprises a strip of material containing a plurality of light emitting diodes wherein the strip of material containing light emitting diodes is contained within or attached to a back of the article of apparel.

6. The safety system of claim 1 wherein the device capable of activating the illumination member is connected to the lighting system of the motor vehicle and comprises a coupling member for connecting the activation device to the illumination member.

7. The safety device of claim 6 wherein the coupling member is a magnetic coupling member.

8. The safety device of claim 1 wherein the activation device capable of activating the illumination member comprises wireless technology which enables the device to illuminate the illumination device without using wires connecting the activation device to the illumination member.

9. The safety device of claim 1 wherein the article of apparel comprises a vest that can be worn over any shirt or jacket.

10. The safety device of claim 9 wherein the illumination member is sewn into a back of the vest.

11. A safety device kit comprising:
an illumination member capable of being illuminated that can be contained within, or attached to, a wearable article that can be worn by a user; and
a separate activation device capable of activating the illumination member.

12. The safety device kit of claim 11 wherein the separate activation device is connected to the illumination member and to at least one of a person and an object.

13. The safety device kit of claim 12 wherein the illumination of the illumination member corresponds to at least one of movement and nonmovement of the at least one person and object.

14. The safety device of claim 11 wherein the separate activation device activates the illumination member via wireless technology.
